(19) United States
(12) Patent Application Publication
(10) Pub. No.: US 2017/0115548 A1
(43) Pub. Date: Apr. 27, 2017

(54) SPEED RING FOR PHOTOGRAPHIC LIGHTING APPARATUS

(71) Applicant: LinkedIn Corporation, Mountain View, CA (US)

(72) Inventor: Gregory Alan Pickard, Carpenteria, CA (US)

(21) Appl. No.: 14/922,999

(22) Filed: Oct. 26, 2015

(51) Int. Cl. G03B 15/06

(52) U.S. Cl. CPC G03B 15/06

(57) ABSTRACT

A speed ring can be used to attach a light diffuser, such as a soft box, to a photographic lighting apparatus. For example, the speed ring can couple a light diffuser to a lamp housing of a photographic lighting system. The speed ring may have an overall rectangular appearance, such as a square appearance, and may be described generally as a rectangular frame, such as a square frame, with special adaptations to attach a light diffuser to a photographic lighting apparatus.

### TECHNICAL FIELD

The subject matter disclosed herein generally relates to systems or other apparatus for illumination. Specifically, the present disclosure addresses illumination systems that utilize a speed ring for a photographic lighting apparatus.

### BACKGROUND

A photographic lighting apparatus can be used to illuminate a subject of photography, videography, or other types of image capture. Examples of photographic lighting include studio lighting systems that may be or include photographic lights (e.g., studio lights), photographic lamps (e.g., studio lamps), or any suitable combination thereof. In various situations, it is helpful to modify the light emitted by a photographic lighting apparatus by directing the light through a light diffuser (e.g., a soft box) configured to soften the light from the photographic lighting apparatus (e.g., by spreading or scattering the light). For example, a light diffuser may provide indirect lighting by bouncing the light off one or more surfaces. As another example, a light diffuser may soften the light by passing the light through a light scattering material (e.g., a translucent material). Some light diffusers utilize both techniques.

### BRIEF DESCRIPTION OF THE DRAWINGS

Some embodiments are illustrated by way of example and not limitation in the figures of the accompanying drawings.

FIG. 1 is a top plan view of a speed ring, according to some example embodiments.

FIG. 2 is a front elevation view of the speed ring shown in FIG. 1, according to some example embodiments.

FIG. 3 is a left side elevation view of the speed ring shown in FIG. 1, according to some example embodiments.

FIG. 4 is a bottom plan view of the speed ring shown in FIG. 1, according to some example embodiments.

FIG. 5 is a top-front-left perspective view of the speed ring shown in FIG. 1, according to some example embodiments.

FIG. 6 is a close-up, top-front-left perspective view of a connection brace (e.g., corner brace) of the speed ring shown in FIG. 1, according to some example embodiments.

FIG. 7 is a close-up, top-front-right perspective view of a pull tab of the speed ring shown in FIG. 1, according to some example embodiments.

FIG. 8 is an exploded top view of the speed ring shown in FIG. 1, according to some example embodiments.

FIG. 9 is a close-up, exploded, top-front-left perspective view of a corner portion of the speed ring shown in FIG. 1, according to some example embodiments.

FIG. 10 is a top plan view of a first type (e.g., right-handed version) of connection brace included in the speed ring shown in FIG. 1, according to some example embodiments.

FIG. 11 is a front elevation view of the first type of connection brace, according to some example embodiments.

FIG. 12 is a left side elevation view of the first type of connection brace, according to some example embodiments.

FIG. 13 is a right side elevation view of the first type of connection brace, according to some example embodiments.

FIG. 14 is a bottom plan view of the first type of connection brace, according to some example embodiments.

FIG. 15 is a rear elevation view of the first type of connection brace, according to some example embodiments.

FIG. 16 is a top-front-right perspective view of the first type of connection brace, according to some example embodiments.

FIG. 17 is a bottom-rear-right perspective view of the first type of connection brace, according to some example embodiments.

FIG. 18 is a top plan view of a second type (e.g., left-handed version) of connection brace included in the speed ring shown in FIG. 1, according to some example embodiments.

FIG. 19 is a front elevation view of the second type of connection brace, according to some example embodiments.

FIG. 20 is a left side elevation view of the second type of connection brace, according to some example embodiments.

FIG. 21 is a right side elevation view of the second type of connection brace, according to some example embodiments.

FIG. 22 is a bottom plan view of the second type of connection brace, according to some example embodiments.

FIG. 23 is a rear elevation view of the second type of connection brace, according to some example embodiments.

FIG. 24 is a top-front-left perspective view of the second type of connection brace, according to some example embodiments.

FIG. 25 is a bottom-rear-right perspective view of the second type of connection brace, according to some example embodiments.

FIG. 26 is a left side elevation view of a photographic lighting apparatus (e.g., studio lighting system) that includes a light diffuser (e.g., a soft box), the speed ring shown in FIG. 1, and a lamp housing, according to some example embodiments.

FIG. 27 is a top-front-left perspective view of the photographic lighting apparatus shown in FIG. 26, according to some example embodiments.

FIG. 28 is a top-rear-left perspective view of the photographic lighting apparatus shown in FIG. 26, according to some example embodiments.

### DETAILED DESCRIPTION

Examples of a speed ring are described herein, as well as examples of a soft box (e.g., a soft box apparatus or other light diffusing apparatus) and a photographic lighting apparatus (e.g., a photographic light, photographic lighting system, photographic lamp, or other illumination system). Examples merely typify possible variations. Unless explicitly stated otherwise, structures (e.g., structural components, such as members and other mechanical parts) are optional and may be combined or subdivided. In the following description, for purposes of explanation, numerous specific details are set forth to provide a thorough understanding of example embodiments. It will be evident to one skilled in the art, however, that the present subject matter may be practiced without these specific details.

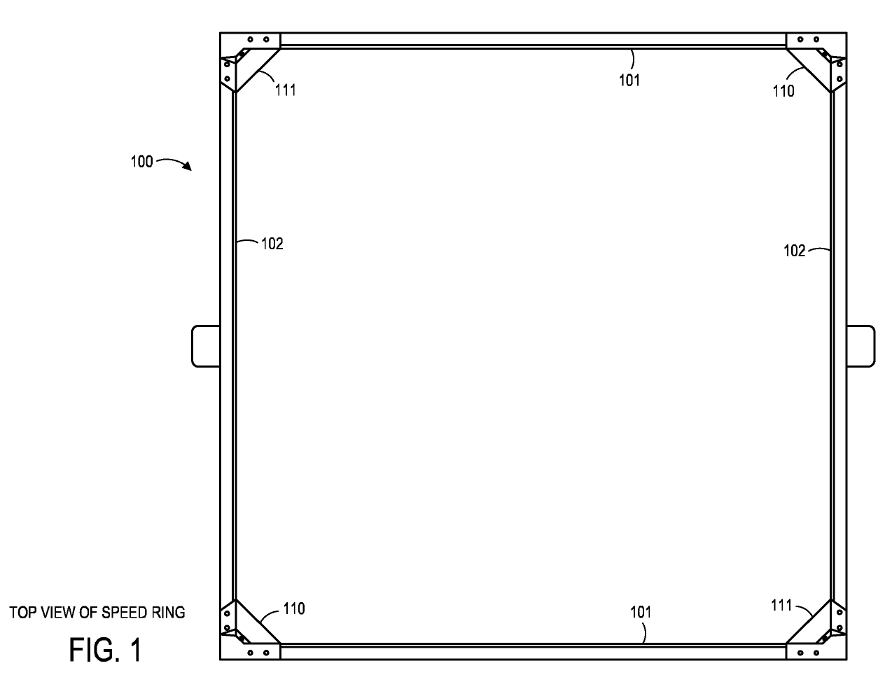

A speed ring can be used to attach (e.g., mount, install, or otherwise affix) a light diffuser, such as a soft box, to a photographic lighting apparatus (e.g., to a lamp housing of a photographic lighting system). FIG. 1 is a top plan view of a speed ring 100, according to some example embodiments. The speed ring 100 shown in FIG. 1 has an overall rectangular (e.g., square) appearance and may be described generally as a rectangular frame (e.g., square frame) with special adaptations (e.g., a special combination of shapes, contours, dimensions, or other physical features) to perform the functions of a speed ring (e.g., to attach a light diffuser to a photographic lighting apparatus).

As shown in FIG. 1, the speed ring 100 includes multiple (e.g., two, as shown) elongate first members 101 and multiple (e.g., two, as shown) elongate second members 102. The elongate first members 101 and the elongate second members 102 are configured (e.g., positioned, connected, coupled, or otherwise arranged) in a circumferential arrangement (e.g., a rectangle, a square, a polygon, or a complex shape). The elongate first members 101 form parallel straight sides of the circumferential arrangement. As shown in FIG. 1, the elongate first members 101 form parallel straight sides of a rectangular circumferential arrangement.

Although FIG. 1 depicts the elongate second members 102 also forming parallel straight sides of the rectangular circumferential arrangement, the elongate second members 102 may form nonparallel and non-straight sides of certain alternative (e.g., nonrectangular) circumferential arrangements, according to various example embodiments. Thus, the elongate second members 102 may form one or more curves and may themselves be curved.

As further shown in FIG. 1, the speed ring 100 includes multiple connection braces 110 and 111 that each couple one of the elongate first members 101 to one of the elongate second members 102. According to the example embodiments illustrated in FIG. 1, this coupling is substantially perpendicular. In the rectangular circumferential arrangement of the speed ring 100 depicted in FIG. 1, a first type of connection brace 110 (e.g., right-handed version) is used on two diagonally opposing corners of the rectangular circumferential arrangement, and a second type of connection brace 111 (e.g., left-handed version) is used on the other two diagonally opposing corners of the rectangular circumferential arrangement.

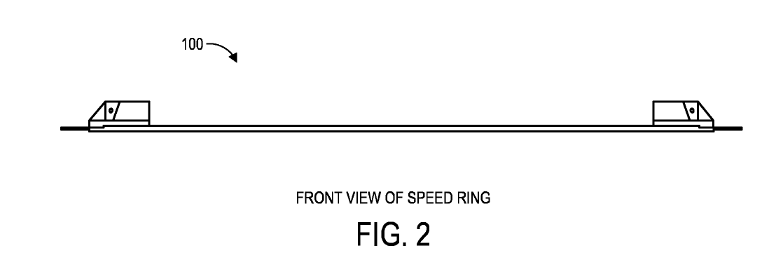

FIG. 2 is a front elevation view of the speed ring 100 shown in FIG. 1, according to some example embodiments. For clarity, several reference numerals are not shown. However, the front elevation view of the speed ring 100 can also be described as an edge view of the rectangular circumferential arrangement, in which edge view an elongate first member 101 is visible, along with a connection brace 110 of the first type (shown on the left side of the figure) and a connection brace 111 of the second type (shown on the right side of the figure).

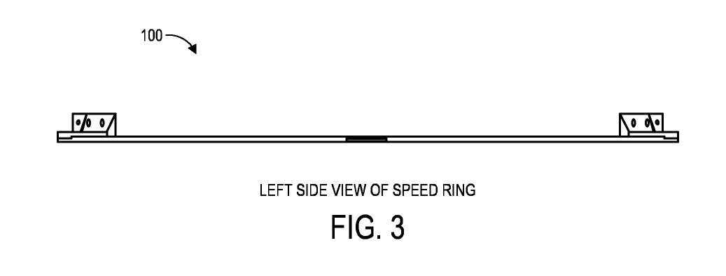

FIG. 3 is a left side elevation view of the speed ring 100 shown in FIG. 1, according to some example embodiments. For clarity, several reference numerals are not shown. However, the left side elevation view of the speed ring 100 can also be described as edge view of the rectangular circumferential arrangement, in which edge view an elongate second member 102 is visible, along with a connection brace 111 of the second type (shown on the left side of figure) and a connection brace 110 of the first type (shown on the right side of the figure).

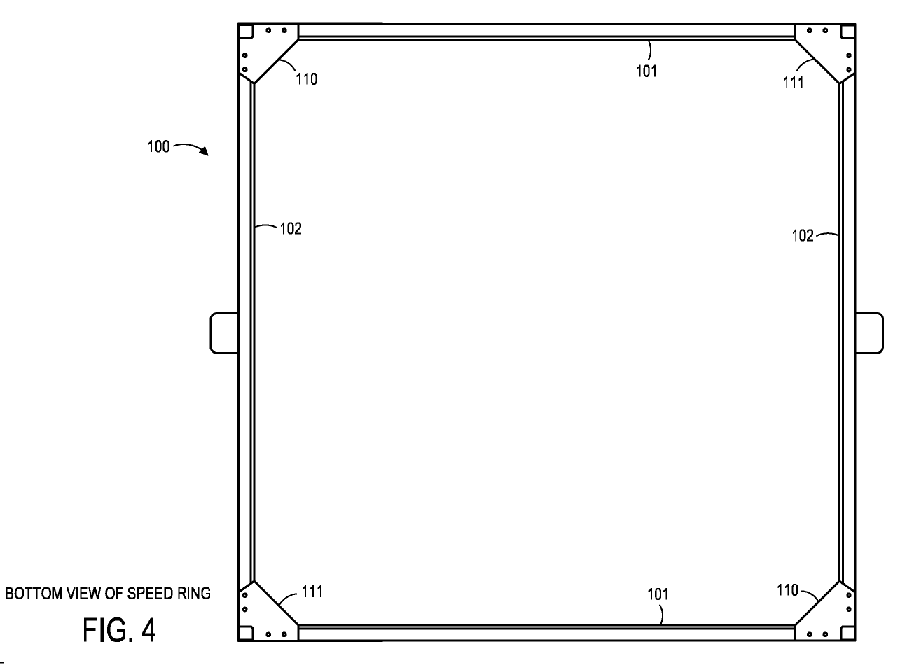

FIG. 4 is a bottom plan view of the speed ring 100 shown in FIG. 1, according to some example embodiments. As noted above, the elongate first members 101 and the elongate second members 102 form a circumferential arrangement. In FIG. 4, the circumferential arrangement is rectangular (e.g., square). The elongate first members 101 form parallel straight sides of the circumferential arrangement. In the example embodiments illustrated in FIG. 4, the elongate second members 102 also form parallel straight sides of the circumferential arrangement, though this need not be the case. Moreover, FIG. 4 depicts connection braces 110 and 111, each coupling one of the elongate first members 101 with one of the elongate second members 102. Such couplings may be substantially perpendicular, as shown in FIG. 4.

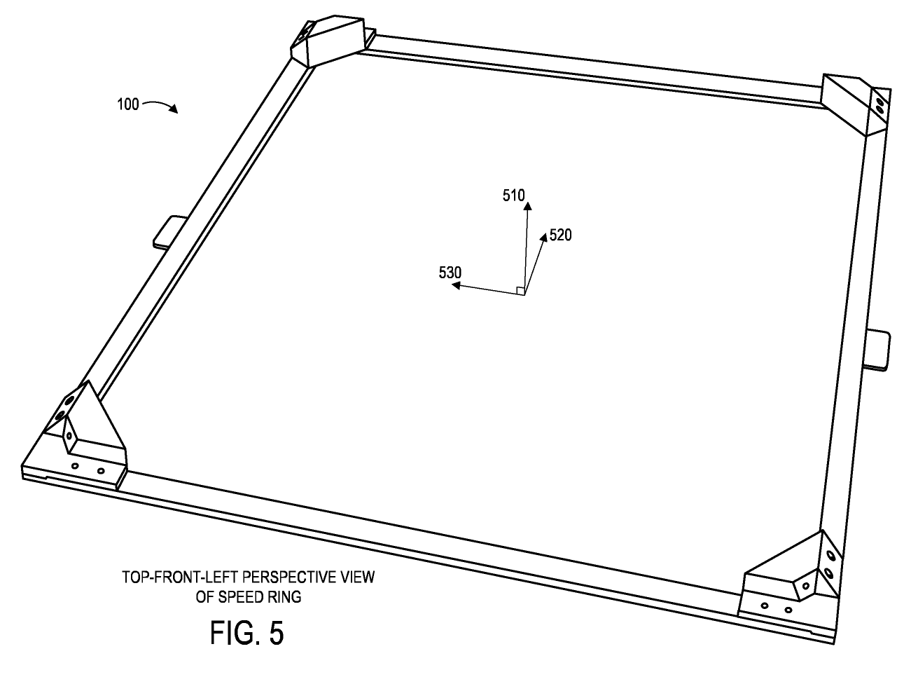

FIG. 5 is a top-front-left perspective view of the speed ring 100 shown in FIG. 1, according to some example embodiments. For clarity, several reference numerals are not shown. However, the top-front-left perspective view of the speed ring 100 is depicted with orthogonal axes to facilitate description of directions and orientation. Specifically, the circumferential arrangement of the elongate first and second members 101 and 102 has a normal direction 510, and the normal direction 510 is perpendicular to a plane formed by the elongate first and second members 101 and 102.

In addition, the circumferential arrangement has a reference direction 520, and the reference direction 520 is both perpendicular to the normal direction 510 and perpendicular to the parallel straight sides formed by the elongate first members 101. In certain situations, the reference direction 520 may be treated as a vertical or upward direction with respect to a lamp housing of a photographic lighting apparatus or a vertical or upward direction with respect to Earth's gravity. Measured in the normal direction 510, each of the elongate first members 101 has a thickness (e.g., member thickness). In various example embodiments of the speed ring 100, the thicknesses of the elongate first members 101 in the normal direction 510 are uniform.

Furthermore, the circumferential arrangement has a lateral direction 530, and the lateral direction is both perpendicular to the normal direction 510 and perpendicular to the reference direction 520. In certain situations, the lateral direction 530 may be treated as a horizontal or sideways direction with respect to a lamp housing of a photographic lighting apparatus or a horizontal or sideways direction with respect to Earth's gravity.

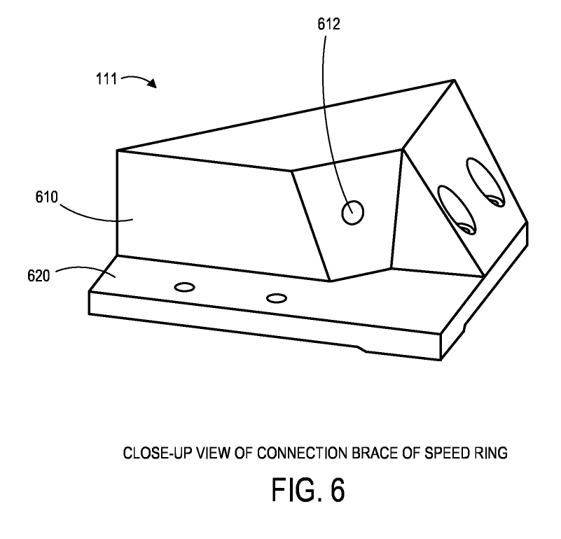

FIG. 6 is a close-up, top-front-left perspective view of a connection brace 111 of the second type (e.g., left-handed version), according to some example embodiments. As shown in FIG. 6, the connection brace 111 (e.g., corner brace) has a protrusion 610 that extends in the normal direction 510 or parallel to the normal direction 510. The connection brace 111 additionally has a flange 620 that extends in the reference direction 520 or parallel to the reference direction 520. According to certain example embodiments, the protrusion 610 and the flange 620 can be described as extending substantially perpendicularly away from each other.

Similar features are present in a connection brace 110 (e.g., corner brace) of the first type (e.g., right-handed version). In various example embodiments, the connection braces 110 of the first type are substantially mirror images of the connection braces 111 of the second type.

As shown in FIG. 6, the protrusion 610 has a cavity 612. The cavity 612 has a mouth, and the mouth of the cavity 612 has a cross-sectional area that, when viewed along the normal direction 510, does not overlap any part of the flange 620. The cavity 612 may penetrate all the way through the connection brace 110 or 111 but need not do so, depending on specific example embodiments. Briefly returning to FIG. 1, according to various example embodiments, the cross-sectional area of the mouth of the cavity 612 does not overlap any of the elongate first members 101, the elongate second members 102, or both, when viewed along the normal direction 510. Briefly returning to FIG. 2, according to certain example embodiments, the cross-sectional area of the mouth of the cavity 612 does not overlap any of the elongate first members 101, when viewed along the reference direction 520.

Returning to FIG. 6, the flange 620 has a thickness (e.g., flange thickness). According to various example embodiments of the speed ring 100, the thickness of the flange 620 in the normal direction 510 is no greater than 12.2 millimeters minus the member thickness of the elongate first members 101 in the normal direction 510. That is, the sum of the member thickness and the flange thickness is no greater than 12.2 millimeters in such example embodiments of the speed ring 100. This maximum total thickness of an elongate first member 101 and a flange 620 of a connection brace 110 or 111 may provide the benefit of allowing the speed ring 100 to be attached to certain lamp housings of certain photographic lighting apparatus. In particular, certain lamp housings (e.g., lamp housings of Parabeam® lights by Kino Flo®) may be equipped with one or more channel rails (e.g., as accessory rails or accessory adapters) that accept objects whose total thickness is no more than 12.2 millimeters.

In certain example embodiments, the member thickness of the elongate first members 101 is not uniform in the lateral direction 530, and the outer surfaces of the elongate first members 101 and the flanges 620 of the connection braces 110 and 111 in the normal direction 510 may be flush with each other. A similar situation may exist with respect to the elongate second members 102 and the connection braces 110 and 111. According to various example embodiments, one or more of the connection braces 110 and 111 may be integrated with one or more of the elongate first and second members 101 and 102 (e.g., manufactured, cast, milled, three-dimensionally printed, or any suitable combination thereof, as a single article or component). In such example embodiments, whether or not there is a clear demarcation between a connection brace 110 or 111 and an elongate first or second member 101 or 102, the total thickness of the speed ring 100 in the normal direction 510 at locations corresponding to the flanges 620 of the connection braces 110 and 111 may be adapted for insertion into one of the channel rails of certain lamp housings. Accordingly, the maximum total thickness of the speed ring 100 in the normal direction 510 at such locations may be 12.2 millimeters.

Moreover, in some example embodiments of the speed ring 100, the flange thickness of the flange 620 is no less than 10.2 millimeters minus the member thickness of the elongate first members 101 in the normal direction 510. In other words, the sum of the member thickness and the flange thickness is no less than 10.2 millimeters in such example embodiments. This minimum total thickness of an elongate first member 101 and a flange 620 of a connection brace 110 or 111 may provide the benefit of a snug, yet slidably movable, fit between the speed ring 100 and the one or more channel rails of certain lamp housings. Accordingly, in certain example embodiments, the combined thickness of a flange 620 and an elongate first member 101 falls within the range of 10.2 and 12.2 millimeters. In example embodiments in which one or more of the elongate first and second members 101 and 102 are integrated with one or more of the connection braces 110 and 111, or any other situation in which there is no clear demarcation between a connection brace 110 or 111 and an elongate first or second member 101 or 102, the minimum total thickness of the speed ring 100 in the normal direction 510 at locations corresponding to the flanges 620 of the connection braces 110 and 111 may be 10.2 millimeters.

According to some example embodiments, the cavity 612 has a longitudinal axis that intersects the cross-sectional area of the mouth of the cavity 612. In particular, the longitudinal axis of the cavity 612 may intersect a centroid of the cross-sectional area. Hence, the cavity 612 may have axial symmetry about its longitudinal axis. For example, the cavity 612 may be cylindrical (e.g., cylindrically shaped or drilled), and in such cases, the cross-sectional area of the mouth of the cavity 612 may accordingly be ellipsoid (e.g., circular).

Briefly returning to FIG. 5 and with reference to FIG. 1, for each of the connection braces 110 and 111, the flange 620 has a first surface (e.g., a bottom surface or portion thereof) that faces one of the elongate first members 101. In particular, the flange 620 may have a bottom surface or portion thereof that faces (e.g., faces and contacts) the elongate first member 101 being coupled to an elongate second member 102 by that connection brace 110 or 111. Furthermore, for each of the connection braces 110 and 111, the flange 620 has a second surface (e.g., a top surface or portion thereof) opposite the first surface and facing away from the elongate first member 101 being coupled to an elongate second member 102 by the connection brace 110 or 111. As can be seen from FIG. 5 and FIG. 6, the flange thickness of the flange 620 is defined in the normal direction 510 by the first and second surfaces (e.g., bottom and top surfaces) of the flange 620.

Returning to FIG. 6, for each of the connection braces 110 and 111, the protrusion 610 has a first surface (e.g., a bottom surface or portion thereof) that faces one of the elongate second members 102. In particular, the protrusion 610 may have a bottom service or portion thereof that faces (e.g., faces and contacts) the elongate second member 102 being coupled to an elongate first member 101 by that connection brace 110 or 111. Moreover, for each of the connection braces 110 and 111, the protrusion 610 has a second surface (e.g., a top surface, side surface, or portion thereof) that includes the mouth of the cavity 612. As can be seen from FIG. 5 and FIG. 6, the mouth of the cavity 612 is positioned on the surface of the protrusion 610 other than the surface that faces (e.g., faces and contacts) the elongate second member 102 being coupled by that connection brace 110 or 111.

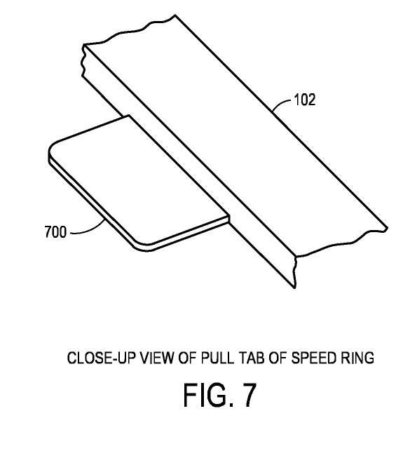

FIG. 7 is a close-up, top-front-right perspective view of a pull tab 700 of the speed ring 100 shown in FIG. 1, according to some example embodiments. The pull tab 700 may be an integral part of an elongate second member 102 or a separate component affixed to the elongate second member 102. The pull tab 700 may provide the benefit of allowing the speed ring 100, when attached to a photographic lighting apparatus, to be easily detached from the photographic lighting apparatus, for example, by being grabbed by the pull tab 700 and slidably moved out of one or more channel rails of the photographic lighting apparatus. Briefly returning to FIG. 1, opposing instances of the pull tab 700 may enable the speed ring 100 to be pulled forward or backward in the lateral direction 530 or parallel to the lateral direction 530. Furthermore, as shown in FIG. 1 and FIG. 5, one or more pull tabs 700 may protrude away from the circumferential arrangement of the elongate first and second members 101 and 102. In particular, one or more of the pull tabs 700 may protrude in the lateral direction 530 or parallel to the lateral direction 530. That is, a pull tab 700 may protrude from an elongate second member 102 in a direction perpendicular to the normal direction 510 and perpendicular to the reference direction 520.

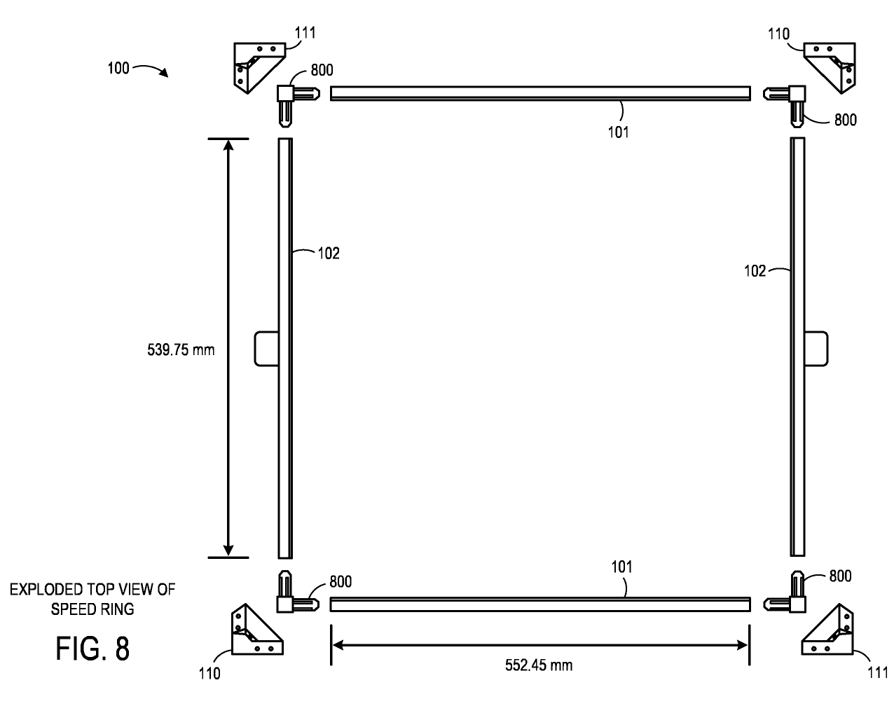

FIG. 8 is an exploded top view of the speed ring 100 shown in FIG. 1, according to some example embodiments. Example dimensions are shown to clearly illustrate a specific example embodiment of the speed ring 100. Other dimensions are contemplated, however. FIG. 8 shows that each connection brace 110 or 111 can couple (e.g., connect) one elongate first member 101 with one elongate second member 102, and this coupling can be enhanced (e.g., augmented or strengthened) with a rigid connector 800. In FIG. 8, each of the rigid connectors 800 joins (e.g., substantially perpendicularly) one of the elongate first members 101 to one of the elongate second members 102.

Briefly considering FIG. 1, FIG. 5, and FIG. 8 together, in many example embodiments of the speed ring 100, each of the connection braces 110 and 111 couples one of the elongate first members 101 to one of the elongate second members 102 at a same angle (e.g., 90 degrees). In such example embodiments, in each of the connection braces 110 and 111, the cavity 612 may have a longitudinal axis that is parallel to a plane formed by the normal direction 510 and a line that bisects the same angle at which each of the connection braces 110 and 111 couples one of the elongate first members 101 to one of the elongate second members 102. For example, where a connection brace 110 or 111 couples its elongate first and second members 101 and 102 at a 90 degree angle, the longitudinal axis of its cavity 612 may lie within a plane formed by the normal direction 510 and a 45 degree line that intersects the corner tip of the connection brace 110 or 111.

As shown in FIG. 8, each of the elongate first members 101 has a longitudinal axis (e.g., first longitudinal axis), and within the circumferential arrangement of the elongate first and second members 101 and 102, the longitudinal axis of the elongate first members 101 may be perpendicular to the reference direction 520 and perpendicular to the normal direction 510. Moreover, each of the elongate first members 101 may have a same length (e.g., a uniform first length of 552.45 millimeters) along its longitudinal axis.

As additionally shown in FIG. 8, each of the elongate second members 102 has a longitudinal axis (e.g., a second longitudinal axis), and within the circumferential arrangement of the elongate first and second members 101 and 102, the longitudinal axis of the elongate second members 102 may be parallel to the reference direction 520 and perpendicular to the normal direction 510. Furthermore, each of the elongate second members 102 may have a same length (e.g., a uniform second length of 539.75 millimeters) along its longitudinal axis.

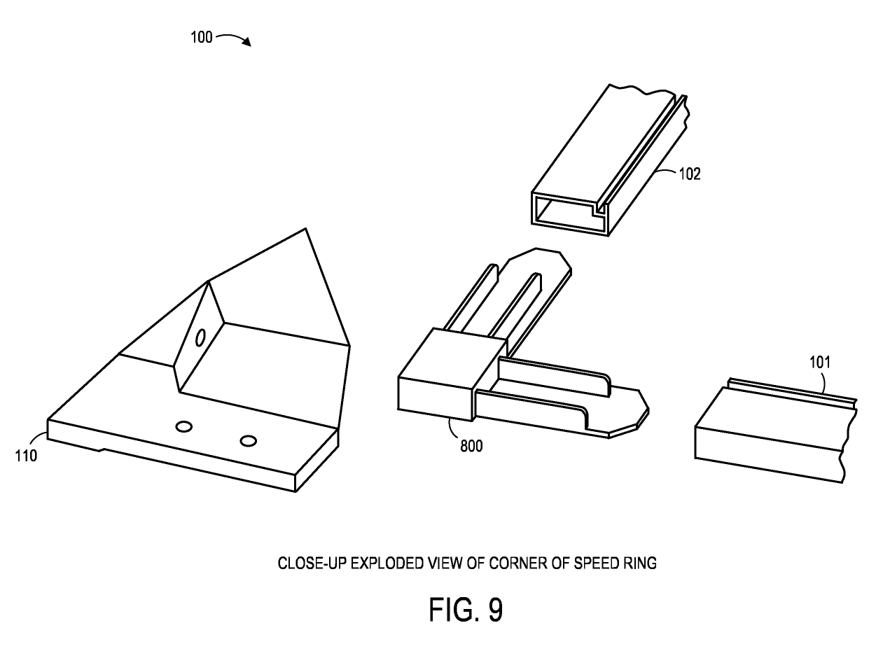

FIG. 9 is a close-up, exploded, top-front-left perspective view of a corner portion of the speed ring 100 shown in FIG. 1, according to some example embodiments. As shown in FIG. 9, a rigid connector 800 may be shaped, manufactured, milled, or otherwise adapted to join one of the elongate first members 101 with one of the elongate second members 102, informing the circumferential arrangement of the elongate first and second members 101 and 102 within the speed ring 100. The rigid connector 800 shown in FIG. 9 has two insertable portions, one adapted for insertion into an elongate first member 101, the other adapted for insertion into an elongate second member 102. FIG. 9 also shows a connection brace 110 that may also join the elongate first member 101 to the elongate second member 102 (e.g., via one or more fasteners, such as nails or screws).

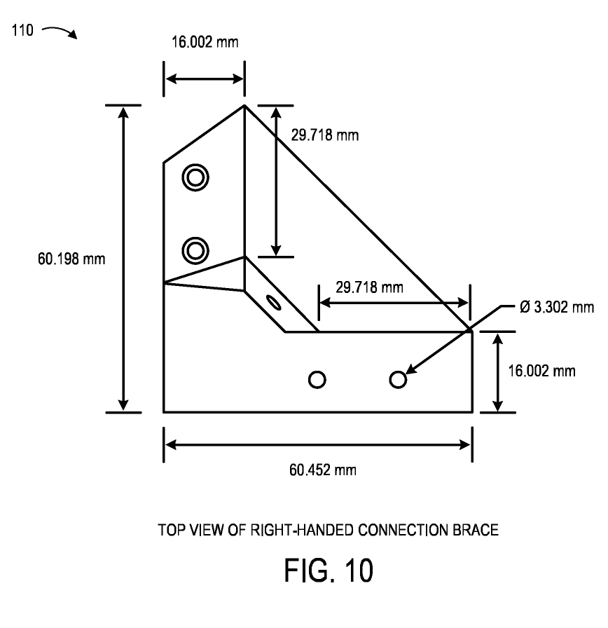

FIG. 10 is a top plan view of a connection brace 110, which can be described as a first type (e.g., right-handed version) of connection brace, included in the speed ring shown in FIG. 1, according to some example embodiments. Example dimensions are shown to clearly illustrate a specific example embodiment of the connection brace 110, though other example embodiments utilize other dimensions.

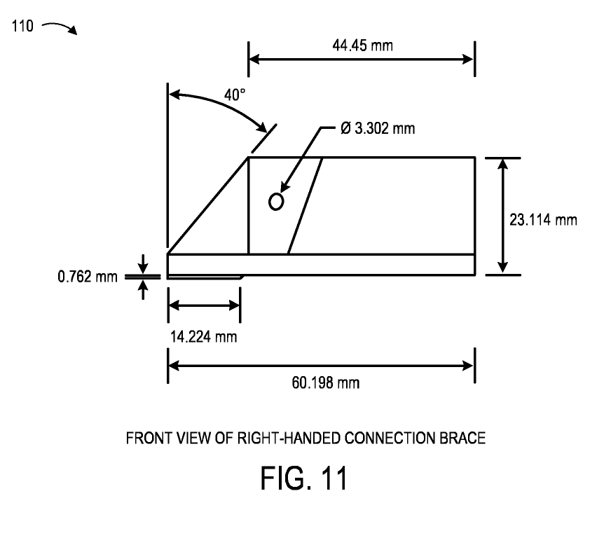

FIG. 11 is a front elevation view of the connection brace 110, according to some example embodiments. Example dimensions are provided to clearly illustrate a specific example embodiment of the connection brace 110, though other example embodiments utilize other dimensions.

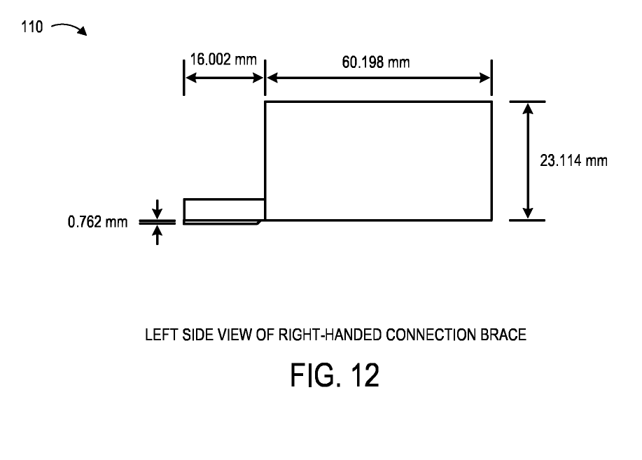

FIG. 12 is a left side elevation view of the connection brace 110, according to some example embodiments. Example dimensions are given to clearly illustrate a specific example embodiment of the connection brace 110, though other dimensions are used in other example embodiments.

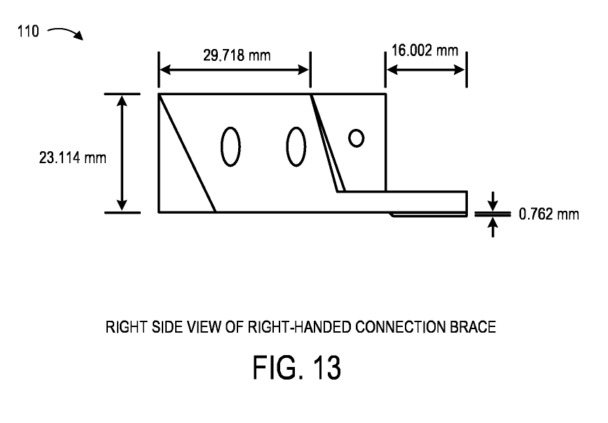

FIG. 13 is a right side elevation view of the connection brace 110, according to some example embodiments. Example dimensions are shown to clearly illustrate a specific example embodiment of the connection brace 110, though alternative dimensions are utilized in alternative example embodiments.

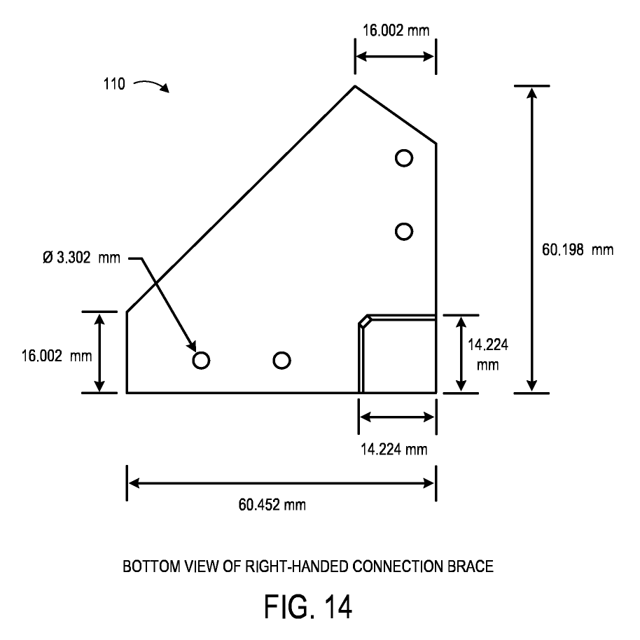

FIG. 14 is a bottom plan view of the connection brace 110, according to some example embodiments. Example dimensions are shown to clearly illustrate a specific example embodiment of the connection brace 110, though other example embodiments utilize other dimensions.

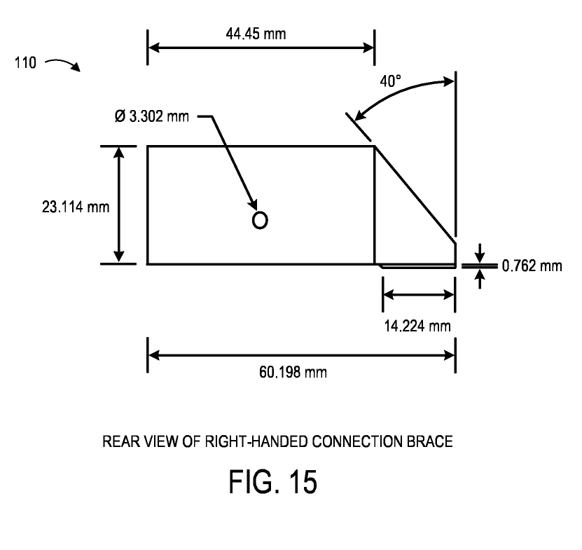

FIG. 15 is a rear elevation view of the connection brace 110, according to some example embodiments. Example dimensions are provided to clearly illustrate a specific example embodiment of the connection brace 110, though other example embodiments utilize other dimensions.

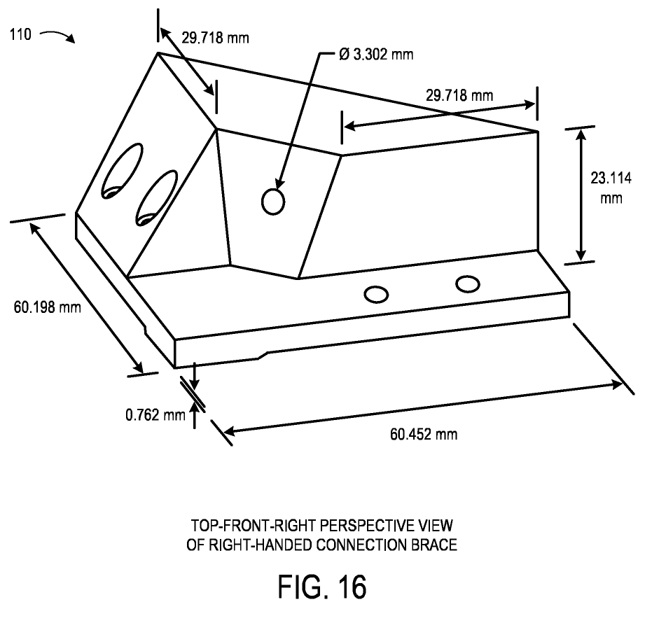

FIG. 16 is a top-front-right perspective view of the connection brace 110, according to some example embodiments. Example dimensions are given to clearly illustrate a specific example embodiment of the connection brace 110, though other dimensions are used in other example embodiments.

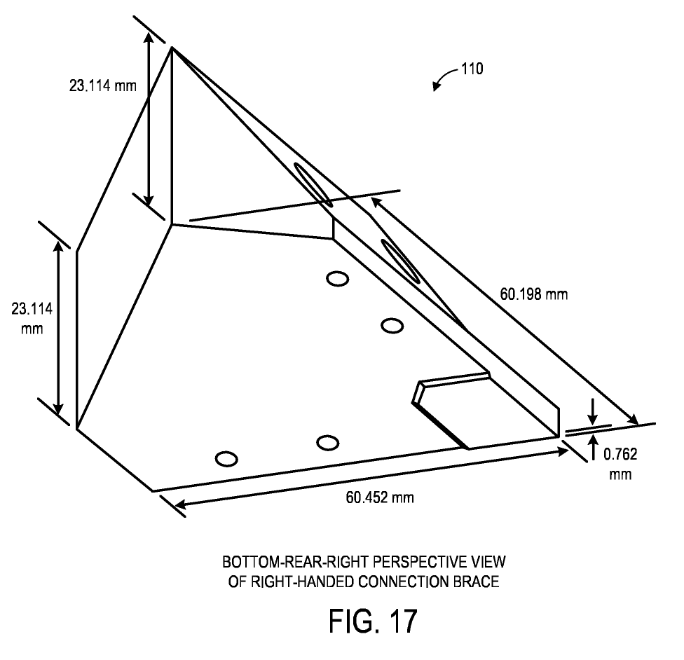

FIG. 17 is a bottom-rear-right perspective view of the connection brace 110, according to some example embodiments. Example dimensions are shown to clearly illustrate a specific example embodiment of the connection brace 110, though alternative dimensions are utilized in alternative example embodiments.

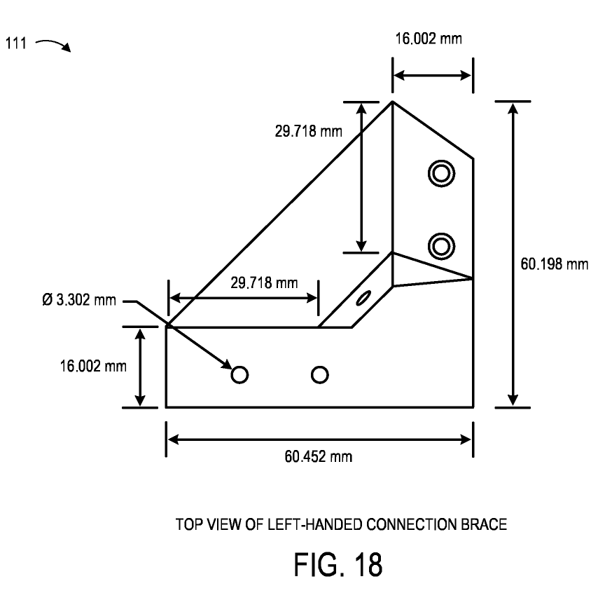

FIG. 18 is a top plan view of a connection brace 111, which can be described as a second type (e.g., left-handed version) of connection brace, included in the speed ring shown in FIG. 1, according to some example embodiments. Example dimensions are shown to clearly illustrate a specific example embodiment of the connection brace 111, though other example embodiments utilize other dimensions.

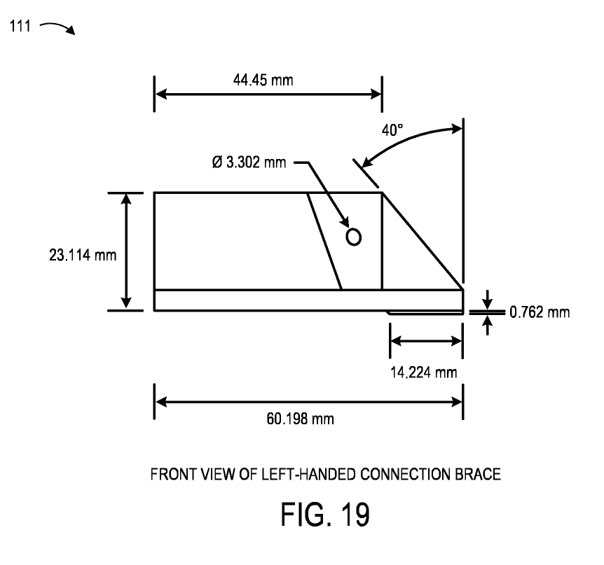

FIG. 19 is a front elevation view of the connection brace 111, according to some example embodiments. Example dimensions are provided to clearly illustrate a specific example embodiment of the connection brace 111, though other example embodiments utilize other dimensions.

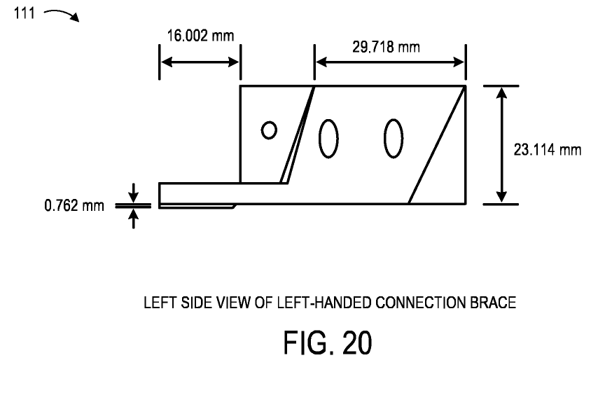

FIG. 20 is a left side elevation view of the connection brace 111, according to some example embodiments. Example dimensions are given to clearly illustrate a specific example embodiment of the connection brace 111, though other dimensions are used in other example embodiments.

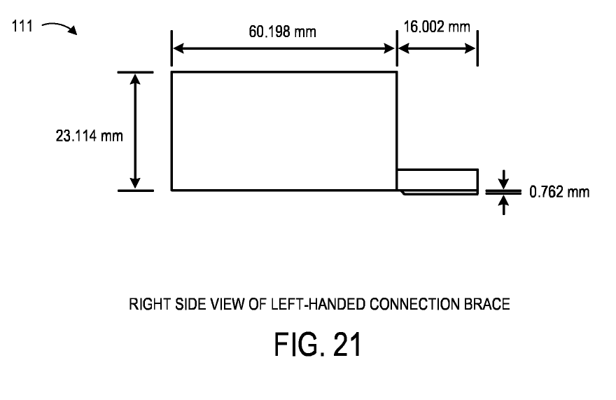

FIG. 21 is a right side elevation view of the connection brace 111, according to some example embodiments. Example dimensions are shown to clearly illustrate a specific example embodiment of the connection brace 111, though alternative dimensions are utilized in alternative example embodiments.

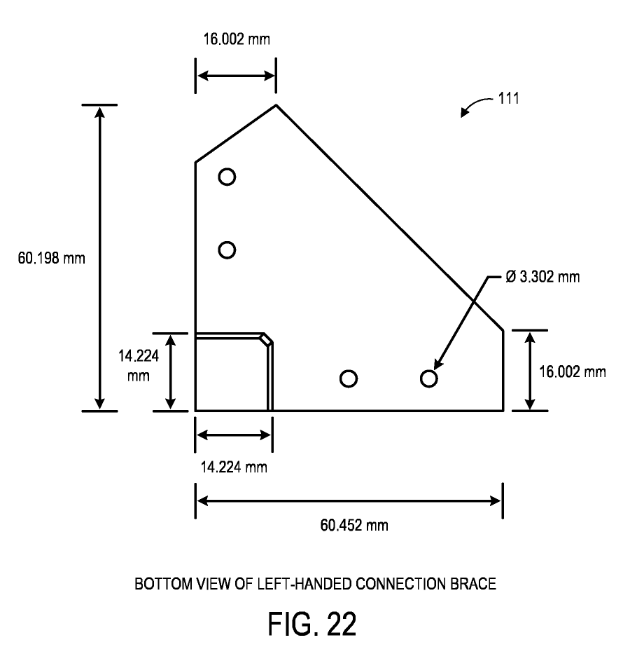

FIG. 22 is a bottom plan view of the connection brace 111, according to some example embodiments. Example dimensions are shown to clearly illustrate a specific example embodiment of the connection brace 111, though other example embodiments utilize other dimensions.

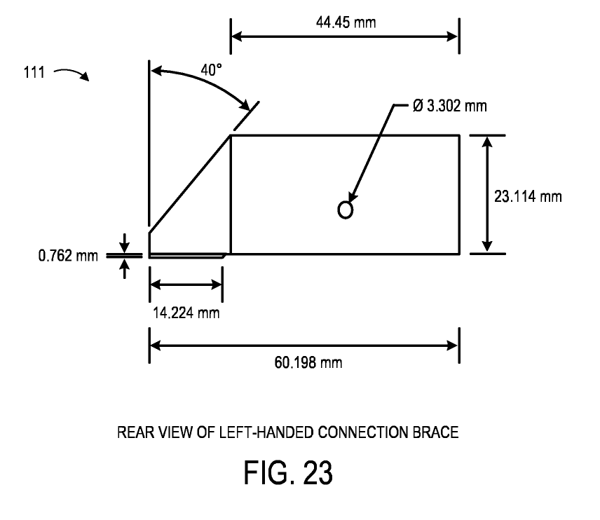

FIG. 23 is a rear elevation view of the connection brace 111, according to some example embodiments. Example dimensions are provided to clearly illustrate a specific example embodiment of the connection brace 111, though other example embodiments utilize other dimensions.

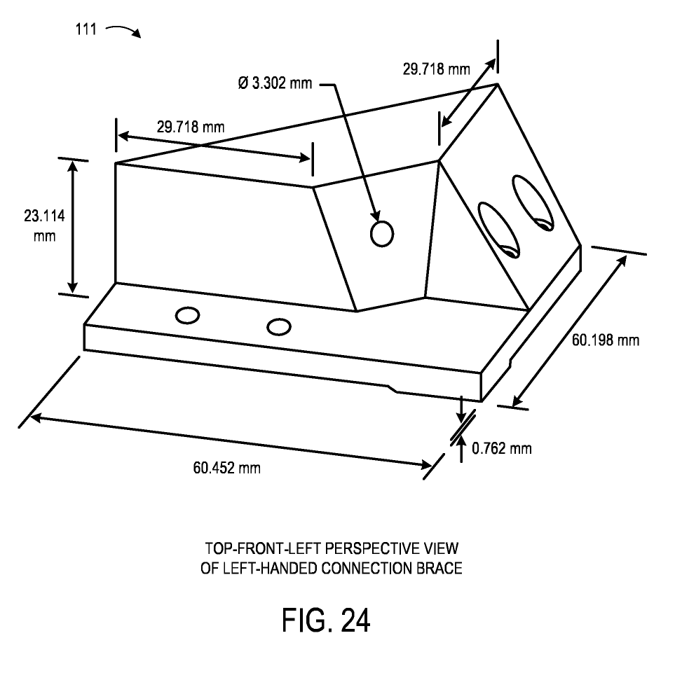

FIG. 24 is a top-front-left perspective view of the connection brace 111, according to some example embodiments. Example dimensions are given to clearly illustrate a specific example embodiment of the connection brace 111, though other dimensions are used in other example embodiments.

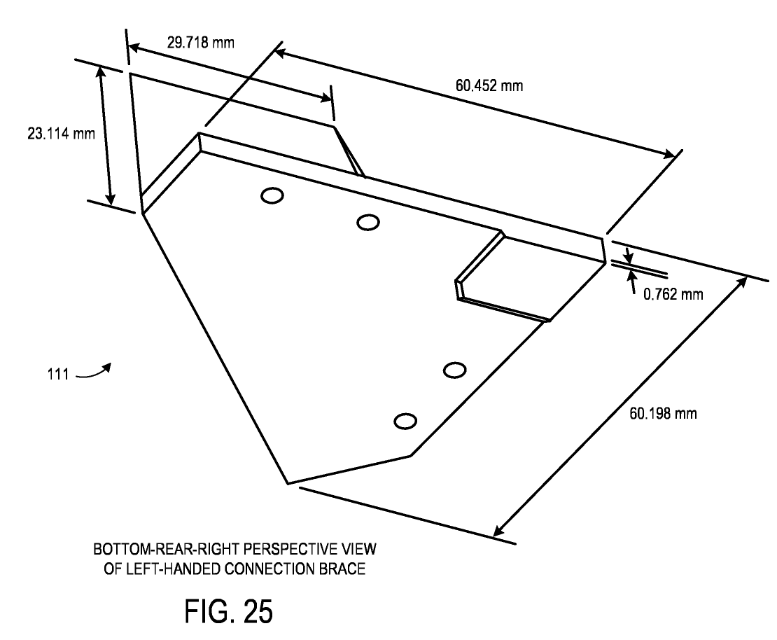

FIG. 25 is a bottom-rear-right perspective view of the connection brace 111, according to some example embodiments. Example dimensions are shown to clearly illustrate a specific example embodiment of the connection brace 111, though alternative dimensions are utilized in alternative example embodiments.

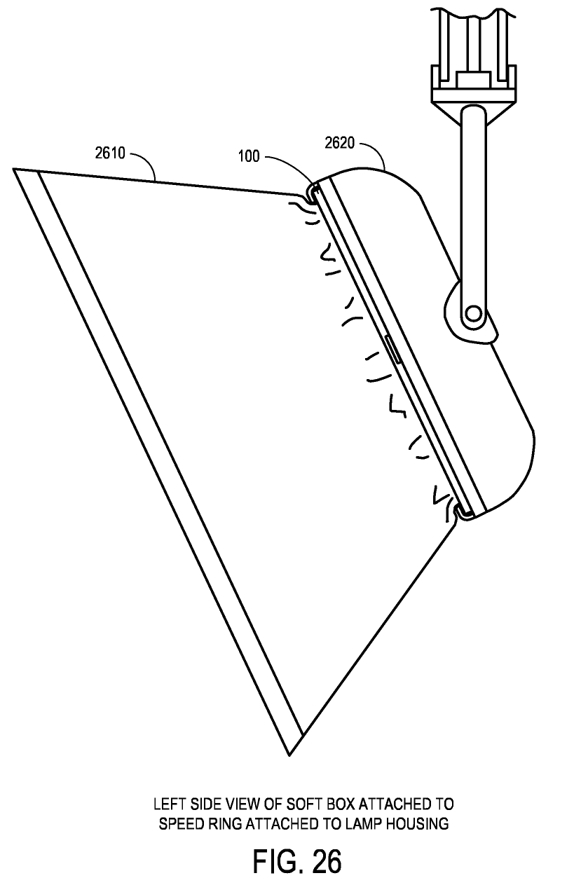

FIG. 26 is a left side elevation view of a photographic lighting apparatus (e.g., studio lighting system) that includes a light diffuser 2610 (e.g., a soft box), the speed ring 100 shown in FIG. 1, and a lamp housing 2620, according to some example embodiments. For clarity, most reference numerals regarding the speed ring 100 are not shown.

The light diffuser 2610 includes multiple (e.g., four) elongate ribs that are coupled by opaque panels (e.g., flexible or rigid opaque fabric panels). Each of the opaque panels separates multiple (e.g., two) elongate ribs from each other. According to various example embodiments, each of the opaque panels has a reflective interior surface (e.g., a light diffusing reflective interior surface).

Moreover, according to certain example embodiments, each of the elongate ribs has an insertable end that extends beyond the opaque panels. The insertable end of each elongate rib is insertable into the cavity 612 of a connection brace 110 or 111 of the speed ring 100. Accordingly, the light diffuser 2610 may be coupled to the speed ring 100 by insertion of one or more of the insertable ends of the elongate ribs into their corresponding cavities 612 in the connection braces 110 and 111 of the speed ring 100. That is, each cavity 612 is usable to couple the speed ring 100 to the light diffuser 2610 by enclosing an insertable end of one of the elongate ribs of the light diffuser 2610. Thus, the speed ring 100 may be attached to the light diffuser 2610 to form a soft box (e.g., soft box apparatus).

Furthermore, according to various example embodiments, the light diffuser 2610 includes a translucent panel (e.g., light diffusing translucent panel) whose edges are coupled to one or more of the opaque panels. For example, the opaque panels may constitute side panels (e.g., side walls) of the light diffuser 2610, and the translucent panel may constitute a front panel (e.g., front wall) of the light diffuser 2610. In such example embodiments, the circumferential arrangement of the elongate first and second members 101 and 102 of the speed ring 100 may have an interior void through which light can pass. Thus, the circumferential arrangement may enable light to pass through the interior void and reach the translucent panel of the light diffuser 2610.

As shown in FIG. 26, the lamp housing 2620 contains a set of one or more lamps that are configured, positioned, or otherwise arranged to shine light through a front opening (e.g., rectangular front opening) of the lamp housing 2620. The front opening of the lamp housing 2620 may be rectangular and may have two opposing edges along each of which a channel rail is affixed. As noted above, the lamp housing 2620 (e.g., a lamp housing of a Parabeam® light by Kino Flo®) may be equipped with channel rails (e.g., as accessory rails or accessory adapters) that accept objects whose total thickness is no more than 12.2 millimeters. In the example embodiments illustrated in FIG. 26, channel rails are affixed to the top and bottom edges of the rectangular front opening of the lamp housing 2620.

Accordingly, the speed ring 100 may be coupled to the lamp housing 2620 by full or partial insertion of one or more flanges 620 of one or more connection braces 110 or 111 (e.g., along with full or partial insertion of one or more elongate first members 101). That is, each channel rail of the lamp housing 2620 is usable to couple the speed ring 100 to the lamp housing 2620 by partially enclosing one or more of the flanges 620 of the speed ring 100. In other words, each flange 620 (e.g., with its corresponding elongate first member 101) is usable to couple the speed ring 100 to the lamp housing 2620 by being at least partially inserted into a channel rail of the lamp housing 2620. When configured (e.g., manufactured or assembled) as shown in FIG. 26, the photographic lighting apparatus allows light to shine from the set of lamps in the lamp housing 2620, through the interior void of the speed ring 100 (e.g., the interior void formed by the circumferential arrangement of the elongate first and second members 101 and 102), to reach the translucent panel of the light diffuser 2610.

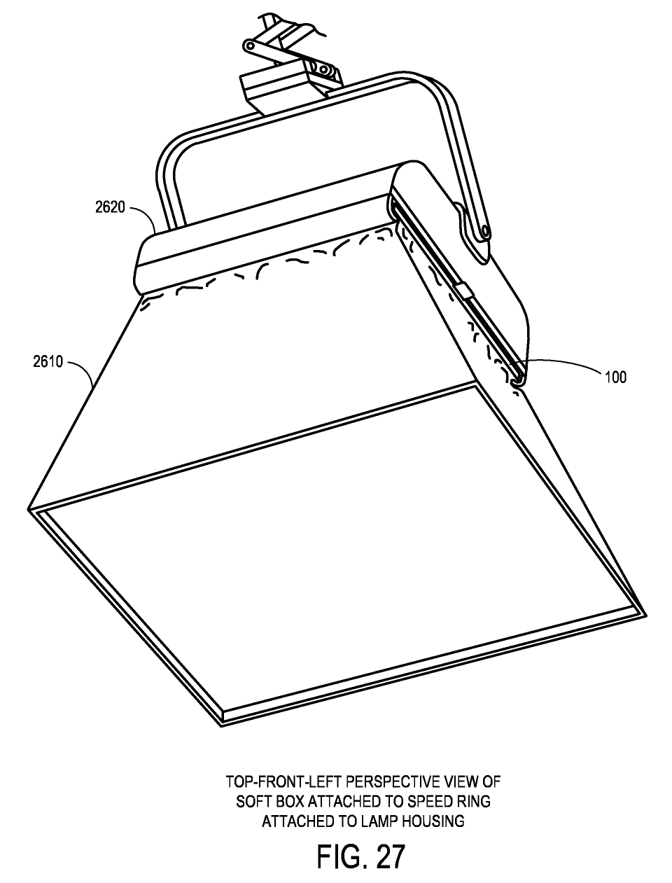

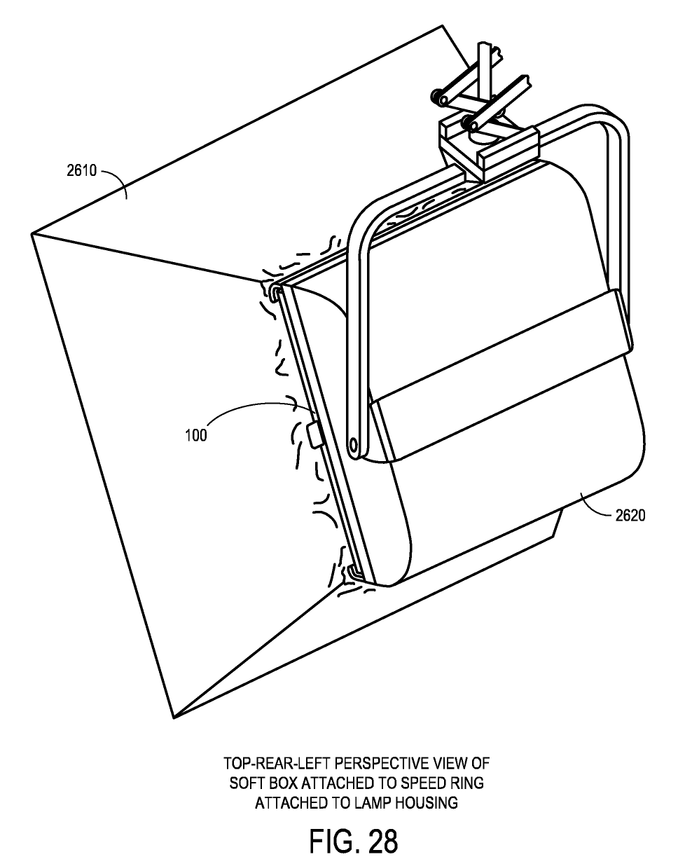

FIG. 27 is a top-front-left perspective view of the photographic lighting apparatus shown in FIG. 26, according to some example embodiments. FIG. 28 is a top-rear-left perspective view of the photographic lighting apparatus shown in FIG. 26, according to some example embodiments. For clarity, most reference numerals regarding the speed ring 100 are not shown in FIG. 27 and FIG. 28.

Throughout this specification, plural instances may implement components or structures described as a single instance. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein. Furthermore, unless specifically stated otherwise, the terms “a” or “an” are herein used, as is common in patent documents, to include one or more than one instance. Finally, as used herein, the conjunction “or” refers to a non-exclusive “or,” unless specifically stated otherwise.

What is claimed is:

1. A speed ring for a photographic lighting apparatus, the speed ring comprising:
multiple elongate first and second members in a circumferential arrangement of which the elongate first members form parallel straight sides, the circumferential arrangement having a normal direction perpendicular to a plane of the elongate members and having a reference direction perpendicular to the normal direction and perpendicular to the parallel straight sides, the elongate first members having a member thickness in the normal direction; and
connection braces each coupling one of the elongate first members to one of the elongate second members, each of the connection braces having a protrusion extending in the normal direction and a flange extending parallel to the reference direction, the flange having a flange thickness no greater than 12.2 millimeters minus the member thickness of the elongate first members in the normal direction, the protrusion having a cavity with a mouth whose cross-sectional area when viewed along the normal direction does not overlap the flange.

2. The speed ring of claim 1, wherein:
for each of the connection braces, the flange thickness is no less than 10.2 millimeters minus the member thickness of the elongate first members in the normal direction.

3. The speed ring of claim 1, wherein:
in each of the connection braces, the cross-sectional area of the mouth of the cavity does not overlap any of the elongate first members when viewed along the reference direction.

4. The speed ring of claim 1, wherein:
in each of the connection braces, the cavity has a longitudinal axis that intersects a centroid of the cross-sectional area of the mouth of the cavity.

5. The speed ring of claim 1, wherein:
in each of the connection braces, the cavity is cylindrical, and the cross-sectional area of the mouth of the cavity is ellipsoid.

6. The speed ring of claim 1, wherein:
in each of the connection braces, the cross-sectional area of the mouth of the cavity is circular.

7. The speed ring of claim 1, wherein:
for each of the connection braces, the flange has a first surface that faces one of the elongate first members and a second surface opposite the first surface, the flange thickness being defined in the normal direction by the first and second surfaces of the flange.

8. The speed ring of claim 1, wherein:
for each of the connection braces, the protrusion has a first surface that faces one of the elongate second members and a second surface that includes the mouth of the cavity.

9. The speed ring of claim 1, wherein:
at least one of the elongate second members comprises a pull tab protruding away from the circumferential arrangement in a direction perpendicular to the normal direction and to the reference direction.

10. The speed ring of claim 1, wherein:
each of the connection braces couples one of the elongate first members to one of the elongate second members at a same angle; and
in each of the connection braces, the cavity has a longitudinal axis parallel to a plane formed by the normal direction and a line that bisects the same angle.

11. The speed ring of claim 1, wherein:
the elongate first members each have a first longitudinal axis perpendicular to the reference direction and to the normal direction and each have a same first length along the first longitudinal axis; and
the elongate second members each have a second longitudinal axis parallel to the reference direction and each have a same second length along the second longitudinal axis.

12. The speed ring of claim 1, wherein:
each of the connection braces further comprises a rigid connector that perpendicularly joins one of the elongate first members to one of the elongate second members.

13. A soft box for a photographic lighting apparatus, the soft box comprising:
a light diffuser that comprises elongate ribs coupled by opaque panels that each separate multiple of the elongate ribs, each of the opaque panels having a reflective interior surface, each of the elongate ribs having an insertable end that extends beyond the opaque panels; and
a speed ring that comprises:
multiple elongate first and second members in a circumferential arrangement of which the elongate first members form parallel straight sides, the circumferential arrangement having a normal direction perpendicular to a plane of the elongate members and having a reference direction perpendicular to the normal direction and perpendicular to the parallel straight sides, the elongate first members having a member thickness in the normal direction; and
connection braces each coupling one of the elongate first members to one of the elongate second members, each of the connection braces having a protrusion extending in the normal direction and a flange extending parallel to the reference direction, the flange having a flange thickness no greater than 12.2 millimeters minus the member thickness of the elongate first members in the normal direction, the protrusion having a cavity with a mouth whose cross-sectional area when viewed along the normal direction does not overlap the flange; and wherein
in each of the connection braces, the cavity couples the speed ring to the light diffuser by enclosing the insertable end of one of the elongate ribs of the light diffuser.

14. The soft box of claim 13, wherein:
for each of the connection braces, the flange thickness is no less than 10.2 millimeters minus the member thickness of the elongate first members in the normal direction.

15. The soft box of claim 13, wherein:
for each of the connection braces, the flange has a first surface that faces one of the elongate first members and a second surface opposite the first surface, the flange thickness being defined in the normal direction by the first and second surfaces of the flange.

16. The soft box of claim 13, wherein:
the light diffuser further comprises a translucent panel whose edges are coupled to the opaque panels; and
the circumferential arrangement of the elongate first and second members of the speed ring has an interior void that enables light to pass through the interior void and reach the translucent panel of the light diffuser.

17. A photographic lighting apparatus comprising:
a lamp housing that contains a set of lamps arranged to shine light through a rectangular front opening of the lamp housing, the rectangular front opening having two opposing edges along each of which a channel rail is affixed;
a light diffuser that comprises elongate ribs coupled by opaque panels that each separate multiple of the elongate ribs, each of the opaque panels having a reflective interior surface, each of the elongate ribs having an insertable end that extends beyond the opaque panels; and
a speed ring that comprises:
multiple elongate first and second members in a circumferential arrangement of which the elongate first members form parallel straight sides, the circumferential arrangement having a normal direction perpendicular to a plane of the elongate members and having a reference direction perpendicular to the normal direction and perpendicular to the parallel straight sides, the elongate first members having a member thickness in the normal direction; and
connection braces each coupling one of the elongate first members to one of the elongate second members, each of the connection braces having a protrusion extending in the normal direction and a flange extending parallel to the reference direction, the flange having a flange thickness no greater than 12.2 millimeters minus the member thickness of the elongate first members in the normal direction, the protrusion having a cavity with a mouth whose cross-sectional area when viewed along the normal direction does not overlap the flange; and wherein
in each of the connection braces, the cavity couples the speed ring to the light diffuser by enclosing the insertable end of one of the elongate ribs of the light diffuser, and the flange couples the speed ring to the lamp housing by being at least partially inserted into one of the channel rails of the lamp housing.

18. The photographic lighting apparatus of claim 17, wherein:
for each of the connection braces, the flange thickness is no less than 10.2 millimeters minus the member thickness of the elongate first members in the normal direction.

19. The photographic lighting apparatus of claim 17, wherein:
in each of the connection braces, the cross-sectional area of the mouth of the cavity does not overlap any of the elongate first members when viewed along the reference direction.

20. The photographic lighting apparatus of claim 17, wherein:
the light diffuser further comprises a translucent panel whose edges are coupled to the opaque panels; and
the circumferential arrangement of the elongate members of the speed ring has an interior void that enables light to pass through the interior void and reach the translucent panel of the light diffuser.
